(19) United States
(12) Patent Application Publication
(10) Pub. No.: US 2024/0216830 A1
(43) Pub. Date: Jul. 4, 2024

(54) HYDROSOL PREPARATION SYSTEM

(71) Applicant: PEOPLEFISH ENERGY INTIATIVE CO., LTD., Taipei City (TW)

(72) Inventor: LI-Ling HSU, Taipei City (TW)

(21) Appl. No.: 18/523,937

(22) Filed: Nov. 30, 2023

(30) Foreign Application Priority Data
Dec. 28, 2022 (TW) 111214450

(51) Int. Cl. B01D 11/02; B01D 3/40; B01D 61/14; B01D 61/18; B01D 69/02; B67C 3/24; B67C 3/26; B67C 7/00

(52) U.S. Cl. CPC B01D 11/0292; B01D 3/40; B01D 11/028; B01D 61/147; B01D 61/18; B01D 69/02; B67C 3/24; B67C 3/26; B67C 7/0026; B01D 2325/02834; B67C 2003/228; B67C 2007/006

(57) ABSTRACT

A hydrosol preparation system includes a conveyance unit, a distillation unit, a sterilization unit, and a filling unit. The conveyance unit is for conveying a container. The distillation unit performs distillation on a raw material to produce a crude hydrosol. The sterilization unit performs sterilization on the crude hydrosol to produce a final hydrosol. The filling unit fills the final hydrosol into the container. The preparation system integrates all procedures required by manufacturing of the hydrosol product so as to eliminate the need of transferring the semifinished hydrosol product among different production sites, thereby minimizing the risk of inclusion of impurities and maximizing safety and storability of the finished hydrosol product.

### BACKGROUND OF THE INVENTION

### 1. Technical Field

The present invention relates to preparation systems, and more particularly to a hydrosol preparation system.

### 2. Description of Related Art

Hydrosols are produced by distilling plant materials with water. Through distillation, essential oil floats on water as a lipophilic liquid, and the water vapor carrying aromatic substances condenses into a hydrophilic liquid, which is known as a hydrosol.

In a hydrosol, essential oil only takes up a small part and the staple is plant-based water-soluble components, so a hydrosol has smell and chemical properties much milder than those of the corresponding pure essential oil. For this reason, applications of hydrosols have been increasingly extensive. In addition to aromatherapeutic use, hydrosols are also used as soother for daily skincare in virtue of the anti-inflammatory organic acids contained therein.

Many products made from hydrosols, such as toner, hair lotion, and bath salt, are intended to directly contact user skin in use, making it important to ensure safety and shelf life of hydrosol products by eliminating existence of substances that may degrade the hydrosol, such as suspended solids, bacteria, viruses, macro-molecular colloids, etc., in hydrosol products during production.

However, according to the conventional manufacturing practice, the process from distillation to packaging is usually done in a staged manner and conducted by several makers, so the semifinished hydrosol product has to be transferred from one site to another site during this process. Consequently, the semifinished hydrosol product is likely to be contaminated by impurities, risking the quality and safety of the finished hydrosol product.

### SUMMARY OF THE INVENTION

In order to address the foregoing issues, the present invention provides a hydrosol preparation system, which integrates all the procedures required by manufacturing a hydrosol product to eliminate the need of transferring the semifinished hydrosol product among different production sites, thereby minimizing the risk of inclusion of impurities and maximizing safety of the finished hydrosol product.

Hence, a hydrosol preparation system according to one embodiment of the present invention comprises a conveyance unit, a distillation unit, a sterilization unit, and a filling unit. The conveyance unit is used to convey a container. The distillation unit is located beside the conveyance unit and performs distillation on a raw material so as to produce a crude hydrosol. The sterilization unit is located beside the distillation unit and connected to the distillation unit. The sterilization unit performs sterilization on the crude hydrosol so as to generate a final hydrosol. The filling unit is located above the conveyance unit and connected to the sterilization unit. The filling unit fills the final hydrosol into the container.

With the configuration described previously, the hydrosol preparation system of the present invention integrates all procedures required by manufacturing of the hydrosol product so as to eliminate the need of transferring the semifinished hydrosol product among different production sites, thereby minimizing the risk of inclusion of impurities and maximizing safety and shelf life of the finished hydrosol product.

### BRIEF DESCRIPTION OF THE DRAWINGS

FIG. 1 is a schematic diagram showing that a container is fed into the conveyance unit through the entrance according to one embodiment of the present invention; and

FIG. 2 is a schematic diagram showing that the filling unit filling the container with the final hydrosol according to the embodiment of the present invention.

### DETAILED DESCRIPTION OF THE INVENTION

While a preferred embodiment is provided hereinafter for illustrating the concept of the present invention being described above, it is to be understood that the components of the embodiment shown in the accompanying drawings are depicted for the sake of easy explanation and need not to be made to exact scale.

It is to be noted that spatial descriptions, such as “up,” “down,” “front,” “back,” “left,” “right,” “inside,” “outside,” “lateral” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

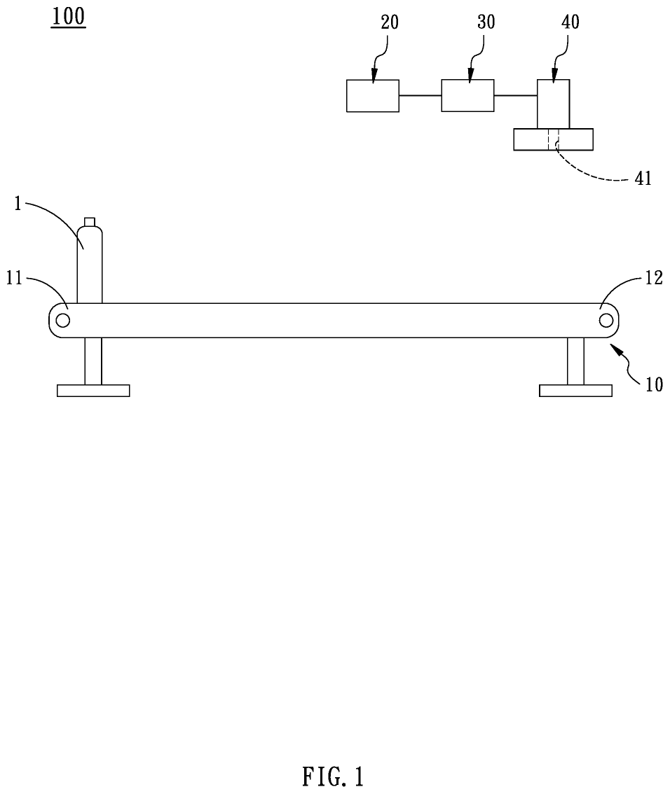

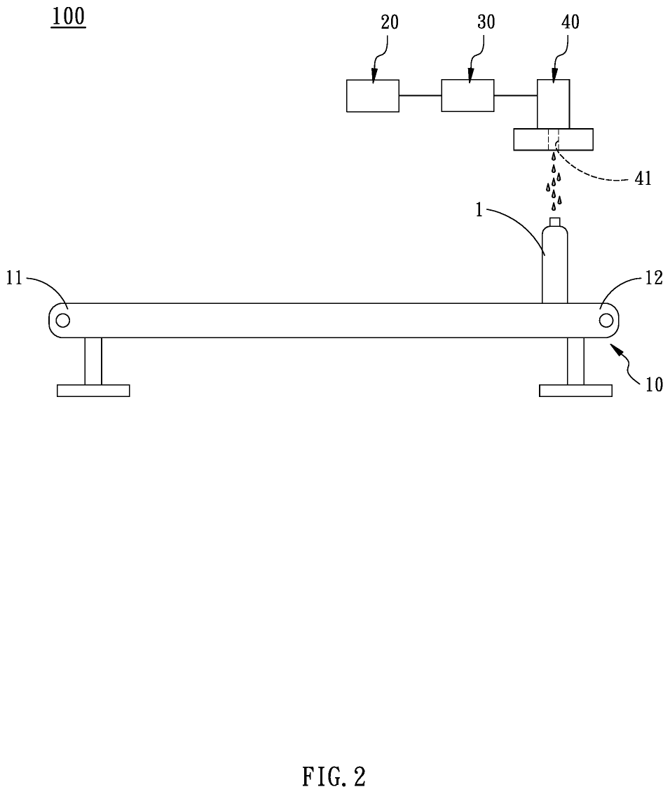

Referring to FIG. 1 and FIG. 2, in one embodiment of the present invention, a hydrosol preparation system 100 comprises a conveyance unit 10, a distillation unit 20, a sterilization unit 30, and a filling unit 40. The distillation unit 20 and the sterilization unit 30 are both located beside the conveyance unit 10. The filling unit 40 is located above the conveyance unit 10. The distillation unit 20 and the sterilization unit 30 are connected to each other. The sterilization unit 30 and the filling unit 40 are connected to each other.

The conveyance unit 10 has an entrance 11 and an exit 12. The conveyance unit 10 is for conveying a container 1 fed into the conveyance unit 10 through the entrance 11, as shown in FIG. 1. The conveyance unit 10 conveys the container 1 to pass through the filling unit 40, and the filled container 1 leaves the conveyance unit 10 at the exit 12, as shown in FIG. 2. In the embodiment of the present invention, the container 1 is a spray bottle made of aluminum. The spray bottle is a fully-sealed bottle that is designed to prevent unintentional opening. This prevents the hydrosol, after being filled into the container 1, from contacting the ambient air, and thereby protects the hydrosol product from degradation caused by air exposure. Besides, since the container 1 has undergone gamma-ray radiation sterilization before entering the conveyance unit 10, survival of microorganisms in the container 1 can be significantly reduced, and potential adverse effects of the environment in the container 1 on the quality of the hydrosol can be minimized. Also, gamma-ray sterilization used herein helps prevent substances harmful to the human body from remaining in the container 1.

The distillation unit 20 is located beside the conveyance unit 10. For example, the distillation unit 20 may be located above the conveyance unit 10. The distillation unit 20 performs pure-water distillation on a raw material so as to produce a crude hydrosol. The raw material may be any aromatic plant, such as rose, lavender, or tea tree. In the embodiment of the present invention, the distillation unit 20 comprises a distillation pot made of copper, which ensures good thermal conductivity and releases copper ions during distillation, while being capable of capturing sulfur compounds, thereby preventing the hydrosol from containing excessive sulfur compounds and smelling pungent.

The sterilization unit 30 is located beside the distillation unit 20 and between the distillation unit 20 and the filling unit 40. The sterilization unit 30 and the distillation unit 20 are connected to each other through pipes. The sterilization unit 30 performs sterilization on the crude hydrosol to produce a final hydrosol. In the embodiment of the present invention, the sterilization unit 30 and the distillation unit 20 are located above the conveyance unit 10. The sterilization unit 30 comprises a microfiltration membrane, which has a pore size of between 0.2 micrometer and 1 micrometer. The microfiltration membrane filters out at least a part of impurities that adversely affect quality and shelf life of the hydrosol, such as suspended solids, bacteria, viruses, macro-molecular colloids, etc. By removing these undesired substances, the sterilization unit 30 helps maximize safety and shelf life of the hydrosol product.

The filling unit 40 is located above the conveyance unit 10 near the exit 12. The filling unit 40 and the sterilization unit 30 are connected to each other through pipes. The filling unit 40 has a discharge port 41. The filling unit 40 fills the final hydrosol into the container 1 through the discharge port 41, as shown in FIG. 2. In the embodiment of the present invention, the filling unit 40 performs aseptic filling with nitrogen gas.

Nitrogen, as a balance gas among medical gas mixtures, is herein used to adjust gas composition in the product and prevents undesired substances in the filling environment from degrading the hydrosol. Furthermore, in the present invention, the container 1, after being filled with the final product through aseptic filling with nitrogen gas, not only benefits the preservation of the hydrosol but also makes the product versatile by allowing a user to spray the hydrosol in various angles, thereby facilitating application of the hydrosol to various body portions of the user.

To sum up, the present invention has the following benefits.

1. In the present invention, the distillation unit 20, the sterilization unit 30, and the filling unit 40 are integrated into a hydrosol preparation system 100. This eliminates the need of transferring semifinished hydrosol product among different production sites, thereby minimizing the risk of inclusion of impurities and maximizing safety and shelf life of the finished hydrosol product.

2. Since the container 1 is a fully-sealed aluminum spray bottle, the risk of unintentional opening can be eliminated. This prevents the hydrosol, after being filled into the container 1, from contacting the ambient air, and thereby protects the hydrosol product from degradation caused by air exposure.

3. The copper distillation pot of the distillation unit 20 ensures good thermal conductivity and releases copper ions during distillation, while being capable of capturing sulfur compounds that smell pungent, thereby allowing the distilled hydrosol to smell fresh and pleasant.

4. The sterilization unit 30 filters out substances that have adverse effects on the quality of the hydrosol, such as suspended solids and bacteria, so as to prevent the hydrosol product from degradation and improve storability of the hydrosol product.

5. The filling unit 40 performs aseptic filling with nitrogen gas. Nitrogen is herein used to adjust gas composition in the product and prevents undesired substances in the filling environment from degrading the hydrosol. Additionally, the nitrogen-filled spray bottle not only benefits the preservation of the hydrosol but also makes the product versatile by allowing a user to spray the hydrosol in various angles, thereby facilitating application of the hydrosol to various body portions of the user.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A hydrosol preparation system, comprising:
a conveyance unit, being used to convey a container;
a distillation unit, being located beside the conveyance unit and used to perform distillation on a raw material, thereby producing a crude hydrosol;
a sterilization unit, being located beside the distillation unit, connected to the distillation unit, and used to perform sterilization on the crude hydrosol, thereby producing a final hydrosol; and
a filling unit, being located above the conveyance unit, connected to the sterilization unit, and used to fill the final hydrosol into the container.

2. The hydrosol preparation system of claim 1, wherein the filling unit performs aseptic filling with nitrogen gas.

3. The hydrosol preparation system of claim 1, wherein the container is a bottle made of aluminum.

4. The hydrosol preparation system of claim 1, wherein the distillation unit comprises a distillation pot made of copper.

5. The hydrosol preparation system of claim 1, wherein the sterilization unit comprises a microfiltration membrane.

6. The hydrosol preparation system of claim 5, wherein the microfiltration membrane has a pore size of between 0.2 micrometer and 1 micrometer.

7. The hydrosol preparation system of claim 1, wherein the sterilization unit and the distillation unit are located above the conveyance unit.

8. The hydrosol preparation system of claim 7, wherein the conveyance unit comprises an entrance and an exit, in which the filling unit is located near the exit.
